(19) United States
(12) Patent Application Publication
(10) Pub. No.: US 2026/0237732 A1
(43) Pub. Date: Aug. 13, 2026

(54) SOLID ELECTROLYTE AND SOLID ELECTROLYTE BATTERY

(71) Applicant: TDK CORPORATION, Tokyo (JP)

(72) Inventors: Akinobu NOJIMA, Tokyo (JP); Hisashi SUZUKI, Tokyo (JP); Masato KURIHARA, Tokyo (JP)

(73) Assignee: TDK CORPORATIION, Tokyo (JP)

(21) Appl. No.: 19/154,525

(22) PCT Filed: Feb. 8, 2024
(86) PCT No.: PCT/JP2024/004243

§ 371 Date: Aug. 7, 2025

(30) Foreign Application Priority Data
Feb. 13, 2023 (JP) 2023-019751

(51) Int. Cl. H01M 10/0562; H01M 10/052

(52) U.S. Cl. CPC H01M 10/0562; H01M 10/052; H01M 2300/008

(57) ABSTRACT

This solid electrolyte contains, as main elements, lithium, zirconium, sulfur, oxygen, and chlorine, in which in an X-ray diffraction pattern using Cu-Kα as a radiation source, peaks are confirmed at a diffraction angle 2θ=32.0°±0.5°, a diffraction angle 2θ=41.8°±0.5°, and a diffraction angle 2θ=50.4°±0.5°.

### TECHNICAL FIELD

The present invention relates to a solid electrolyte and a solid electrolyte battery.

The present application claims priority on Japanese Patent Application No. 2023-019751 filed on Feb. 13, 2023, the content of which is incorporated herein by reference.

### BACKGROUND ART

In recent years, the development of electronic technology has been remarkable, and portable electronic apparatuses are becoming smaller, lighter, thinner, and more multifunctional. In association with this, there is a strong demand for a battery, which serves as a power source for an electronic apparatus, such that the battery is smaller, lighter, thinner, and more reliable. Therefore, a solid electrolyte battery, which uses a solid electrolyte as an electrolyte, has attracted attention. As solid electrolytes, an oxide-based solid electrolyte, a sulfide-based solid electrolyte, a complex hydride-based solid electrolyte, a halide-based solid electrolyte, and the like are known.

For example, Patent Document 1 discloses a solid electrolyte battery containing a halide-based solid electrolyte represented by Li_{3-2X}M_{X}In_{1-Y}M′_{Y}L_{6-Z}L′_{Z}. In the formula, M and M′ are metal elements, and L and L′ are halogen elements. In addition, X, Y, and Z independently satisfy 0≤X<1.5, 0≤Y<1, and 0≤Z≤6.

In addition, for example, Patent Document 2 discloses a halide-based solid electrolyte represented by Li_{6-3Z}Y_{Z}X₆. In the formula, Z satisfies 0<Z<2, and X is Cl or Br.

### CITATION LIST

### Patent Document

Patent Document 1: Japanese Unexamined Patent Application, First Publication No. 2006-244734
Patent Document 2: PCT International Publication No. WO2018/025582

### SUMMARY OF INVENTION

### Technical Problem

The halide-based solid electrolyte is said to have higher ion conductivity than those of an oxide-based solid electrolyte, a sulfide-based solid electrolyte, a complex hydride-based solid electrolyte, and the like. However, in order to realize high discharge energy, there is a demand for improving ion conductivity.

The present invention has been made in consideration of the above problems, and an object of the present invention is to provide a solid electrolyte and a solid electrolyte battery, which have excellent ion conductivity.

### Solution to Problem

In order to solve the above problems, the following solutions are provided.
(1) A solid electrolyte according to a first aspect contains, as main elements, lithium, zirconium, sulfur, oxygen, and chlorine, in which in an X-ray diffraction pattern using Cu-Kα as a radiation source, peaks are confirmed at a diffraction angle 2θ=32.0°±0.5°, a diffraction angle 2θ=41.8°±0.5°, and a diffraction angle 2θ=50.4°±0.5°.
(2) In the solid electrolyte according to the above aspect (1), the solid electrolyte may be represented by LiₐZr(SOₓ)_{b}Cl₄ . . . (1). The formula (1) satisfies 0.9≤a≤1.8, 0.4<b<1.0, and 0<x≤4.0.
(3) A solid electrolyte battery according to a second aspect includes a positive electrode, a negative electrode, and a solid electrolyte layer sandwiched between the positive electrode and the negative electrode. The solid electrolyte layer contains the solid electrolyte according to the above aspect (1) or (2).

### Advantageous Effects of Invention

The solid electrolyte according to the above aspect has excellent ion conductivity.

### BRIEF DESCRIPTION OF DRAWINGS

FIG. 1 The results obtained by measuring an X-ray diffraction pattern of a solid electrolyte according to the present embodiment.

FIG. 2 A schematic cross-sectional view of a solid electrolyte battery according to the present embodiment.

### DESCRIPTION OF EMBODIMENTS

Hereinafter, the present embodiments will be described in detail with reference to the drawings as appropriate. The drawings that are used in the following description may show characteristic portions in an enlarged scale for convenience in order to facilitate the understanding of the characteristics of the present invention, and thus the dimensional ratios or the like of the respective constitutional elements may differ from the actual ones. The materials, dimensions, and the like, which are exemplified in the following description, are merely examples, and the present invention is not limited thereto. Therefore, an appropriate modification can be made within the scope that does not deviate from the features of the present invention.

In addition, “a±b” indicates a numerical value range that is equal to or larger than (a−b) and equal to or smaller than (a+b).

### “Solid Electrolyte”

A solid electrolyte is a substance that can move ions by applying an electric field from outside. In a case where the solid electrolyte has a high ion conductivity, the exchange of ions in the solid electrolyte battery becomes smoother, and the internal resistance becomes smaller.

A solid electrolyte according to the present embodiment contains lithium, zirconium, sulfur, oxygen, and chlorine as main elements. The main elements are major elements confirmed in the composition analysis, and elements that are present as impurities are excluded from the main elements. The main element is an element that is clearly detected in a composition analysis. The composition analysis is carried out, for example, by X-ray photoelectron spectroscopy (XPS) measurement. The main element is, for example, an element that is responsible for the crystal structure of the solid electrolyte.

The solid electrolyte may consist of a compound containing lithium, zirconium, sulfur, oxygen, and chlorine as main elements, or may contain a substance other than this compound. The substance other than this compound is, for example, a material originating from a raw material powder, which is, for example, Li₂SO₄ or ZrCl₄.

The solid electrolyte may be in a form of a powder (particles) or may be in a form of a sintered body obtained by sintering the powder. In addition, the solid electrolyte may also be a molded body obtained by compressing and molding a powder, a molded body obtained by molding a mixture of a powder and a binder, or a coating film formed by applying a coating material containing a powder, a binder, and a solvent and then carrying out heating to remove the solvent.

The solid electrolyte according to the present embodiment is, for example, a halide-based solid electrolyte represented by LiₐZr(SOₓ)_{b}Cl₄ . . . (1). Formula (1) satisfies 0.9≤a≤1.8, 0.4<b<1.0, and 0<x≤4.0.

In Formula (1), Li is a lithium ion. a satisfies 0.9≤a≤1.8, preferably satisfies 0.9≤a≤1.66, and more preferably satisfies 1.1≤a≤1.4. In the compound represented by Formula (1), in a case where a is in the above-described range, the amount of Li in the compound becomes appropriate, and the ion conductivity of the solid electrolyte layer becomes high.

In Formula (1), Zr is a zirconium ion. Zr is an element that forms the skeleton of the solid electrolyte.

In Formula (1), SOₓ is a sulfate. x satisfies 0<x≤4.0. x preferably satisfies x=4.0. Examples of SOₓ include SO₃, SO₄, SO₅, SO_{3/2}, SO₂, SO_{5/2}, and SO_{7/2}. In a case where the solid electrolyte contains a sulfate, the potential window on the reduction side of the solid electrolyte becomes wider; and thereby, the solid electrolyte is less likely to be reduced.

b satisfies 0.4<b<1.0. In a case where a sulfate is contained, the potential window on the reduction side of the solid electrolyte becomes wider, and thus it is preferable to satisfy 0.45≤b. In addition, in order to prevent a decrease in the ion conductivity of the solid electrolyte due to an excessively large amount of sulfate, b≤0.9 is preferable, b≤0.83 is more preferable, and b≤0.71 is still more preferable.

In Formula (1), Cl is a chloride ion. A Cl ion has a large ionic radius per valence, and in a case where this element is contained in the solid electrolyte, lithium ions flow more easily.

Examples of the solid electrolyte include Li_{1.8}Zr(SO₄)_{0.9}Cl₄, Li_{1.66}Zr(SO₄)_{0.83}Cl₄, L_{1.4}Zr(SO₄)_{0.71}Cl₄, Li_{1.25}Zr(SO₄)_{0.63}Cl₄, Li_{1.1}Zr(SO₄)_{0.56}Cl₄, LiZr(SO₄)_{0.5}Cl₄, and Li_{0.9}Zr(SO₄)_{0.45}Cl₄.

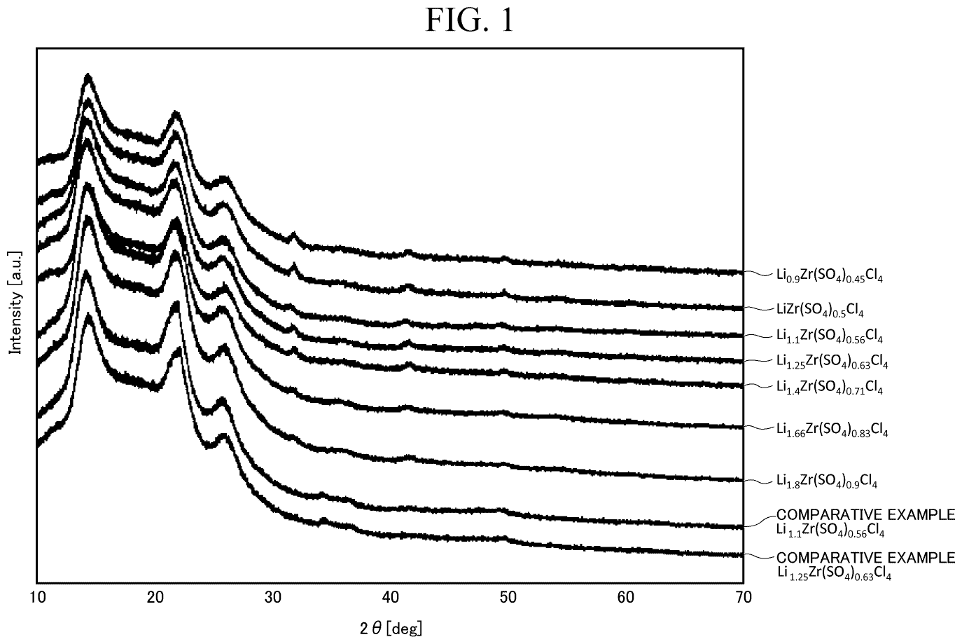

FIG. 1 shows the results (XRD pattern) obtained by subjecting the solid electrolyte according to the present embodiment to measurement by an X-ray diffraction (XRD) method. In FIG. 1, the vertical axis indicates intensity, and the horizontal axis indicates 20. The measurement by the X-ray diffraction method was carried out using a Cu-Kα radiation source. The X-ray diffraction pattern shown in FIG. 1 includes background data from a polyimide tape that was used to prevent contact with the atmospheric air during the measurement. FIG. 1 shows the measurement results of XRD patterns of the solid electrolytes according to the present embodiment as Examples 1 to 7, and XRD patterns of solid electrolytes according to comparative examples, which do not satisfy predetermined features as Comparative Examples 1 and 2.

As shown in FIG. 1, in the solid electrolyte according to the present embodiment, peaks are confirmed at a diffraction angle 2θ=32.0°±0.5°, a diffraction angle 2θ=41.8°±0.5°, and a diffraction angle 2θ=50.4°±0.5° in an X-ray diffraction pattern measured using Cu-Kα as a radiation source. The solid electrolyte according to the present embodiment has crystallinity. On the other hand, a peak is confirmed only at a diffraction angle 2θ=50.4°±0.5° in the X-ray diffraction patterns of the solid electrolytes according to Comparative Examples 1 and 2. A solid electrolyte having a peak at a predetermined position in an X-ray diffraction pattern has high ion conductivity.

### (Method for Producing Solid Electrolyte)

In a case where the solid electrolyte according to the present embodiment is in a powder state, for example, the raw materials Li₂SO₄ and ZrCl₄ are mixed at a predetermined molar ratio and then reacted. In this case, the molar ratio of ZrCl₄ is set to be less than four times the molar ratio of Li₂SO₄. By specifying the molar ratio of ZrCl₄ to Li₂SO₄, the mixing ratio of Li in the solid electrolyte to be produced (range of a) can be set to be in a predetermined range.

The solid electrolyte according to the present embodiment can be produced by mixing the raw materials at a predetermined molar ratio to obtain a mixture, treating the mixture by a mechanochemical method, and then carrying out a heating treatment. By adjusting the mechanochemical reaction, a predetermined solid electrolyte having high ion conductivity can be obtained. In a case where the mechanochemical reaction is insufficient, the solid electrolyte becomes amorphous as shown in the XRD pattern that is shown in the comparative example, and sufficient ion conductivity is not exhibited. In a case of carrying out synthesis by using, for example, a planetary ball mill, the mechanochemical reaction can be controlled by the rotation speed, time, media, and temperature.

In addition, in a case where the solid electrolyte is to be obtained as a sintered body, the mixed raw material powder is molded into a predetermined shape and sintered in a vacuum or in an inert gas atmosphere. ZrCl₄ is easily vaporized in a case where the temperature is increased. For this reason, it is preferable to make up for a shortage of halogen by allowing a halogen gas to coexist in the atmosphere during sintering. In addition, in order to prevent the vaporization of ZrCl₄, sintering may be carried out by using a hot press method using a mold having high airtightness. In this case, since the mold has high airtightness, the vaporization of ZrCl₄ due to sintering can be suppressed. By carrying out sintering in this manner, a solid electrolyte in a state of a sintered body made of a compound having a predetermined composition is obtained.

In addition, in the process of producing the solid electrolyte, a heat treatment may be carried out as necessary. By carrying out the heat treatment, the crystallite size of the solid electrolyte can be adjusted. The heat treatment is preferably carried out at a temperature of 130° C. to 650° C. for 0.5 to 60 hours and more preferably carried out at a temperature of 175° C. to 600° C. for 1 to 30 hours, for example, in an argon gas atmosphere. By carrying out the heat treatment at a temperature of 150° C. to 550° C. for 5 to 24 hours in an argon gas atmosphere, a solid electrolyte having a crystallite size of 5 nm to 500 nm can be obtained.

As described above, the solid electrolyte according to the present embodiment is confirmed to have a specific peak in the X-ray diffraction pattern and thus has high ion conductivity. It is not clear why the ion conductivity increases in a case where the solid electrolyte has a specific peak in the X-ray diffraction pattern; however, the fact that the peak described above has been confirmed is considered to be due to the formation of a predetermined crystal plane; and thereby, a path for the conduction of lithium ions is ensured.

### “Solid Electrolyte Battery”

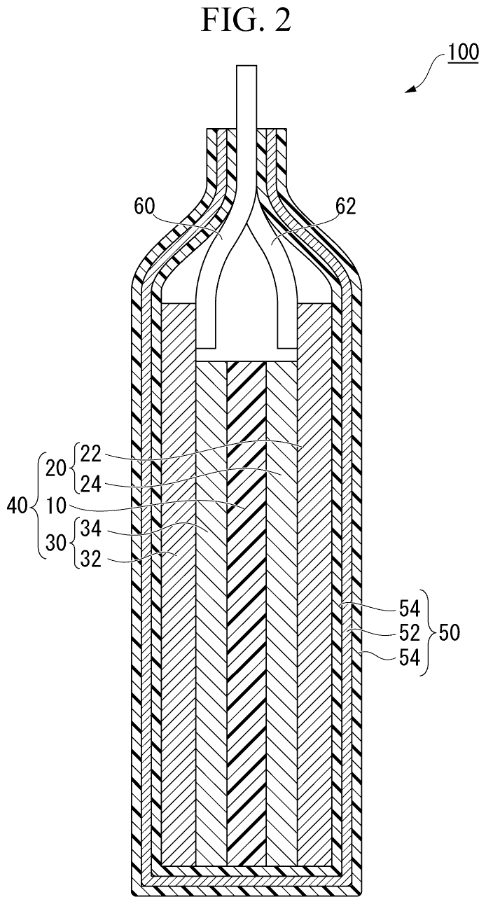

FIG. 2 is a schematic cross-sectional view of a solid electrolyte battery 100 according to the present embodiment. The solid electrolyte battery 100 shown in FIG. 2 includes a power generation element 40 and an exterior body 50. The exterior body 50 covers the periphery of the power generation element 40. The power generation element 40 is connected to the outside by a pair of terminals 60 and 62 which are connected to the power generation element 40. Although a laminated type battery is shown in FIG. 2, a wound type battery may also be used. The solid electrolyte battery 100 is used, for example, in a laminate battery, a square type battery, a cylinder type battery, a coin type battery, and a button type battery.

### <Power Generation Element>

The power generation element 40 includes a solid electrolyte layer 10, a positive electrode 20, and a negative electrode 30. The power generation element 40 is charged or discharged by the exchange of ions between the positive electrode 20 and the negative electrode 30 through the solid electrolyte layer 10 and the exchange of electrons through an external circuit.

### (Solid Electrolyte Layer)

The solid electrolyte layer 10 is sandwiched between the positive electrode 20 and the negative electrode 30. The solid electrolyte layer 10 includes a solid electrolyte that makes it possible to move ions by an externally applied voltage or the like. For example, a solid electrolyte conducts lithium ions and inhibits the movement of electrons.

The solid electrolyte layer 10 contains, for example, the solid electrolyte described above. The solid electrolyte layer 10 may contain a binder in addition to the solid electrolyte described above. Binders described later may be applied as the binder.

### (Positive Electrode)

As shown in FIG. 2, the positive electrode 20 includes a plate-shaped (foil-shaped) positive electrode current collector 22 and a positive electrode mixture layer 24. The positive electrode mixture layer 24 is in contact with at least one surface of the positive electrode current collector 22.

The positive electrode current collector 22 needs only to be made of a material having electron conductivity, which is resistant to oxidation during charging and is resistant to corrosion. The positive electrode current collector 22 is made of, for example, a metal such as aluminum, stainless steel, nickel, or titanium, or a conductive resin. The positive electrode current collector 22 may be in any form of a powder or a foil or in any form of being punched or expanded.

The positive electrode mixture layer 24 contains a positive electrode active material and contains, as necessary, a solid electrolyte, a binder, and a conductive assistant.

The positive electrode active material is not particularly limited as long as it is capable of reversibly progressing the absorbing and releasing of lithium ions and the intercalating and deintercalating (intercalation and deintercalation) of lithium ions, and a positive electrode active material used in a publicly known solid electrolyte battery can be used. Examples of the positive electrode active material include a lithium-containing metal oxide and a lithium-containing metal phosphorus oxide.

Examples of the lithium-containing metal oxide include lithium cobaltate (LiCoO₂), lithium nickelate (LiNiO₂), lithium manganese spinel (LiMn₂O₄), a composite metal oxide represented by a general formula: LiNiₓCo_{y}Mn_{z}O₂ (x+y+z=1), a lithium-vanadium compound (LiVOPO₄ or Li₃V₂(PO₄)₃), an olivine-type LiMPO₄ (M represents at least one selected from Co, Ni, Mn, and Fe), and lithium titanate (Li₄Ti₅O₁₂).

In addition, the positive electrode active material may not contain lithium. Examples of such a positive electrode active material include a non-lithium-containing metal oxide (such as MnO₂ or V₂O₅), a non-lithium-containing metal sulfide (such as MoS₂), and a non-lithium-containing fluoride (such as FeF₃ or VF₃). In a case of using a positive electrode active material that does not contain lithium, the negative electrode is doped with lithium ions in advance, or a negative electrode containing lithium ions is used.

The solid electrolyte contained in the positive electrode 20 is, for example, the solid electrolyte described above. The solid electrolyte contained in the positive electrode 20 may be a halide-based solid electrolyte other than the solid electrolyte described above.

The amount of the solid electrolyte in the positive electrode mixture layer 24 is not particularly limited; however, it is preferably 1% by mass to 50% by mass and more preferably 5% by mass to 30% by mass, based on the sum of the masses of the positive electrode active material, the solid electrolyte, the conductive assistant, and the binder.

The binder binds the positive electrode active material, the solid electrolyte, and the conductive assistant to each other within the positive electrode mixture layer 24, and also firmly bonds the positive electrode mixture layer 24 and the positive electrode current collector 22 together. The positive electrode mixture layer 24 preferably contains a binder. The binder preferably has oxidation resistance and good adhesiveness.

Examples of the binder that is used in the positive electrode mixture layer 24 include polyvinylidene fluoride (PVDF) or a copolymer thereof, polytetrafluoroethylene (PTFE), polyamide (PA), polyimide (PI), polyamideimide (PAI), polybenzimidazole (PBI), polyether sulfone (PES), polyacrylic acid (PA) and a copolymer thereof, a metal ion crosslinked product of polyacrylic acid (PA) and a copolymer thereof, polypropylene (PP) grafted with maleic anhydride, polyethylene (PE) grafted with maleic anhydride, and a mixture thereof. Among these, it is particularly preferable to use PVDF as the binder.

The amount of the solid binder in the positive electrode mixture layer 24 is not particularly limited; however, it is preferably 0.3% by mass to 10% by mass and more preferably 0.3% by mass to 5% by mass, based on the sum of the masses of the positive electrode active material, the solid electrolyte, the conductive assistant, and the binder. In a case where the amount of the binder is too small, it tends to make it impossible to form a positive electrode 20 having sufficient adhesive strength. Conversely, in a case where the amount of the binder is too large, a general binder does not contribute to the discharge capacity since the general binder is electrochemically inactive. Therefore, it tends to be difficult to obtain a sufficient volume or mass energy density.

The conductive assistant improves the electron conductivity of the positive electrode mixture layer 24. As the conductive assistant, a publicly known conductive assistant can be used. Examples of the conductive assistant include a carbon material such as carbon black, graphite, a carbon nanotube, or graphene, a metal such as aluminum, copper, nickel, stainless steel, iron, or an amorphous metal, a conductive oxide such as ITO, and a mixture thereof. The conductive assistant may be in the form of powder or fiber.

The amount of the conductive assistant in the positive electrode mixture layer 24 is not particularly limited. In a case where a conductive assistant is added, the mass ratio of the conductive assistant is, typically, preferably 0.5% by mass to 20% by mass and more preferably 1% by mass to 5% by mass, based on the sum of the masses of the positive electrode active material, the solid electrolyte, the conductive assistant, and the binder.

### (Negative Electrode)

As shown in FIG. 2, the negative electrode 30 includes a negative electrode current collector 32 and a negative electrode mixture layer 34. The negative electrode mixture layer 34 is in contact with the negative electrode current collector 32.

The negative electrode current collector 32 only needs to have electron conductivity. The negative electrode current collector 32 is made of, for example, a metal such as copper, aluminum, nickel, stainless steel, or iron, or a conductive resin. The negative electrode current collector 32 may be in any form of a powder or a foil or in any form of being punched or expanded.

The negative electrode mixture layer 34 contains a negative electrode active material and contains, as necessary, a solid electrolyte, a binder, and a conductive assistant.

The negative electrode active material needs only to enable the reversible progression of absorbing and releasing lithium ions or intercalating and deintercalating lithium ions, and the negative electrode active material is not particularly limited. For the negative electrode active material, a negative electrode active material used in a publicly known solid electrolyte battery can be used.

Examples of the negative electrode active material include a carbon material such as natural graphite, artificial graphite, a mesocarbon microbead, a mesocarbon fiber (MCF), cokes, glassy carbon, or a sintered body of an organic compound, a metal capable of forming a compound with lithium such as Si, SiOₓ, Sn, or aluminum, an alloy thereof, a composite material of these metals and a carbon material, an oxide such as lithium titanate (Li₄Ti₅O₂) or SnO₂, or metallic lithium. The negative electrode active material is preferably natural graphite.

The solid electrolyte contained in the negative electrode 30 is, for example, the solid electrolyte described above. The solid electrolyte contained in the negative electrode 30 may be a halide-based solid electrolyte other than the solid electrolyte described above.

The binder and conductive assistant, which are contained in the negative electrode 30, are the same as the binder and conductive assistant, which are contained in the positive electrode 20.

### <Exterior Body>

The exterior body 50 houses the power generation element 40 in the inside thereof. The exterior body 50 prevents the infiltration of moisture and the like from the outside to the inside. As shown in FIG. 2, the exterior body 50 includes, for example, a metal foil 52 and a resin layer 54 laminated on each side of the metal foil 52. The exterior body 50 is a metal laminate film that is obtained by coating both sides of the metal foil 52 with the resin layer 54.

The metal foil 52 is, for example, an aluminum foil or a stainless steel foil. For the resin layer 54, for, example, a resin film such as polypropylene can be used. The material that constitutes the resin layer 54 may be different between the inner side and the outer side. For example, as a material for the outer side, a polymer having a high melting point, for example, polyethylene terephthalate (PET) or polyamide (PA) can be used, and as a material for the inner side, polyethylene (PE), polypropylene (PP), or the like can be used.

### <Terminal>

The terminals 60 and 62 are connected to the negative electrode 30 and the positive electrode 20, respectively. The terminal 62 connected to the positive electrode 20 is a positive electrode terminal, and the terminal 60 connected to the negative electrode 30 is a negative electrode terminal. The terminals 60 and 62 are responsible for electrical connection to the outside. The terminals 60 and 62 are formed from a conductive material such as aluminum, nickel, copper, or the like. The connection method may be welding or screwing. The terminals 60 and 62 are preferably protected with an insulating tape to prevent short circuits.

### [Method for Manufacturing Solid Electrolyte Battery]

The positive electrode is manufactured by applying a paste containing a positive electrode active material onto the positive electrode current collector 22 and carrying out drying to form the positive electrode mixture layer 24. The above-described solid electrolyte may be added to the paste containing the positive electrode active material.

Next, the negative electrode 30 is prepared. The negative electrode is manufactured by applying a paste containing a negative electrode active material onto the negative electrode current collector 32 and carrying out drying to form the negative electrode mixture layer 34. The above-described solid electrolyte may be added to the paste containing the negative electrode active material.

The power generation element 40 can be produced by, for example, a powder molding method. A guide having a hole part is installed on the positive electrode 20, and a solid electrolyte is packed into the inside of the guide. Thereafter, the surface of the solid electrolyte is smoothed, and the negative electrode 30 is superposed on the solid electrolyte. As a result, the solid electrolyte is sandwiched between the positive electrode 20 and the negative electrode 30. Thereafter, pressure is applied to the positive electrode 20 and the negative electrode 30 to subject the solid electrolyte to pressurization molding. By carrying out pressurization molding, a laminated body in which the positive electrode 20, the solid electrolyte layer 10, and the negative electrode 30 are laminated in this order is obtained.

Next, by a publicly known method, an external terminal is welded to each of the positive electrode current collector 22 of the positive electrode 20 and the negative electrode current collector 32 of the negative electrode 30, which form the laminated body, and the positive electrode current collector 22 or the negative electrode current collector 32 is electrically connected to the external terminal. Thereafter, the laminated body connected to the external terminals is housed in the exterior body 50, and the opening portion of the exterior body 50 is sealed by heat sealing. Through the above-described processes, the solid electrolyte battery 100 according to the present embodiment is obtained.

The solid electrolyte battery 100 according to the present embodiment contains the solid electrolyte described above, and thus the conduction of Li ions is smooth, and the internal resistance is low.

As described above, the embodiments of the present invention have been described in detail with reference to the drawings. However, each of the configurations and the combination thereof in each embodiment are examples, and additions, omissions, substitutions, and other modifications of the configuration can be made without departing from the features of the present invention.

### EXAMPLES

### Example 1

### (Preparation of Solid Electrolyte)

In a glove box with a dew point of about −75° C., raw material powders were weighed out so that the ratio of lithium sulfate (Li₂SO₄) and zirconium chloride (ZrCl₄) was 1:1.1 in terms of molar ratio. Next, the raw material powders were charged into a zirconia airtight container for a planetary ball mill, which had previously contained zirconia balls. Next, a lid was placed on the airtight container, the lid was fixedly screwed to the main body of the container, and the gap between the lid and the container was sealed with a polyimide tape. The polyimide tape has the effect of blocking moisture. Next, the zirconia airtight container was set in a planetary ball mill. The number of rotations was set to 450 rpm, the number of revolutions was set to 450 rpm, the direction of rotation and the direction of revolution were set to be opposite directions with each other, and a mechanochemical reaction was allowed to proceed for 48 hours. Thereafter, the container was placed in a constant temperature chamber at 120° C. for 1 hour and subjected to a heating treatment to generate a solid electrolyte (Li_{1.8}Zr(SO₄)_{0.9}Cl₄).

The planetary ball mill is usually installed in the atmosphere (atmospheric air). The zirconia airtight container for a planetary ball mill is fixedly screwed and further sealed with a polyimide tape, and the zirconia airtight container has a structure of being firmly pressed and fixed in a case where the zirconia airtight container is set in the planetary ball mill. Therefore, even in a usual atmosphere, it is considered that there was almost no infiltration of moisture from the atmospheric air into the zirconia airtight container.

### [XRD Measurement]

The prepared solid electrolyte was packed into a holder for XRD measurement in a glove box with a dew point of about −70° C., in which argon gas was circulated. Thereafter, a polyimide tape (which had been subjected to vacuum drying at 70° C. for 16 hours) for moisture prevention was affixed for sealing so that the packing surface was covered, and a specimen for XRD measurement was prepared. Next, the specimen was taken out into the atmospheric air, and the XRD pattern was measured using an X-ray diffraction apparatus (manufactured by Panalytical, X'PertPro). The X-ray source used was Cu-Kα radiation (measurement wavelength=0.799407 Å).

The X-ray diffraction pattern of the prepared solid electrolyte had peaks at a diffraction angle 2θ=32.0°±0.5°, a diffraction angle 2θ=41.8°±0.5°, and a diffraction angle 2θ=50.4°±0.5°.

### [Measurement of Ion Conductivity]

Next, in a glove box with a dew point of about −70° C., in which argon gas was circulated, the obtained solid electrolyte powder was packed into a pressurization molding die and subjected to pressurization molding with a load of about 30 KN to prepare a measurement cell for ion conductivity.

The pressurization molding die was composed of a cylinder made of polyether ether ketone (PEEK) having a diameter of 10 mm, and an upper punch and a lower punch which were made of an SKD11 material having a diameter of 9.99 mm.

Thereafter, stainless steel disks having a diameter of 50 mm and a thickness of 5 mm and having screw holes at four places, and Teflon (registered trademark) disks were prepared, and a pressurization molding die was set as follows. The loading was carried out in the following order: stainless steel disk/Teflon (registered trademark) disk/die after pressurization molding/Teflon (registered trademark) disk/stainless steel disk, and the screws at the four places were tightened with a torque of about 3 N·m. In addition, screws were inserted into the screw holes provided on the side surfaces of the upper and lower punches; and thereby, the screws were allowed to serve as external connection terminals.

The external connection terminals were connected to a potentiostat (VersaSTAT3 manufactured by Princeton Applied Research) equipped with a frequency response analyzer, and the ion conductivity was measured by an impedance measurement method. The measurement was carried out under conditions where a frequency range was 1 MHz to 0.1 Hz, an amplitude was 10 mV, and a temperature was 25° C. The ion conductivity of the solid electrolyte of Example 1 was 0.34 mS/cm.

### Examples 2 to 7

Examples 2 to 7 differ from Example 1 in that the materials and molar ratios of the raw material powders were changed. The characteristics of the solid electrolyte were also measured in Examples 2 to 7 in the same manner as in Example 1. The molar ratio of lithium sulfate (Li₂SO₄) to zirconium chloride (ZrCl₄) in the production of Examples 2 to 7 is shown below.

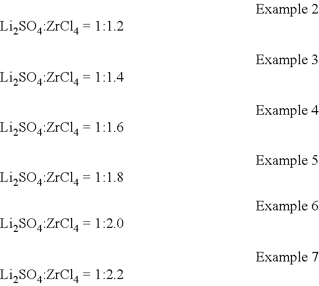

In addition, the solid electrolytes prepared in Examples 2 to 7 were also subjected to an XRD measurement and an ion conductivity measurement in the same manner as in Example 1. In any of the solid electrolytes of Examples 2 to 7, peaks were confirmed at a diffraction angle 2θ=32.0°±0.5°, a diffraction angle 2θ=41.8°±0.5°, and a diffraction angle 2θ=50.4°±0.5° in an X-ray diffraction pattern.

The compositions and ion conductivities of the solid electrolytes prepared in Examples 2 to 7 are shown below.

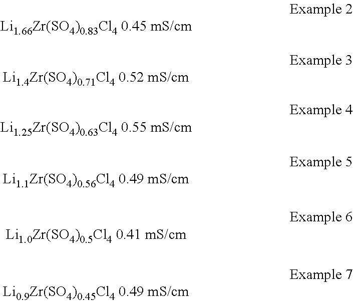

### Comparative Example 1

Comparative Example 1 differs from Example 4 in that, during production, the number of rotations was set to 250 rpm, the number of revolutions was set to 250 rpm, and no subsequent heating treatment was carried out. The composition of the solid electrolyte of Comparative Example 1 was the same as that of Example 4.

In addition, the solid electrolyte of Comparative Example 1 was also subjected to an XRD measurement and an ion conductivity measurement in the same manner as in Example 1. In the X-ray diffraction pattern of the solid electrolyte of Comparative Example 1, peaks were not confirmed at a diffraction angle 2θ=32.0°±0.5° and a diffraction angle 2θ=41.8°±0.5° in an X-ray diffraction pattern. In addition, the ion conductivity of the solid electrolyte of Comparative Example 1 was 0.015 mS/cm.

### Comparative Example 2

Comparative Example 2 differs from Example 5 in that, during production, the number of rotations was set to 250 rpm, the number of revolutions was set to 250 rpm, and no subsequent heating treatment was carried out. The composition of the solid electrolyte of Comparative Example 2 was the same as that of Example 5.

In addition, the solid electrolyte of Comparative Example 2 was also subjected to an XRD measurement and an ion conductivity measurement in the same manner as in Example 1. In the X-ray diffraction pattern of the solid electrolyte of Comparative Example 2, peaks were not confirmed at a diffraction angle 2θ=32.0°±0.5° and a diffraction angle 2θ=41.8°±0.5° in an X-ray diffraction pattern. In addition, the ion conductivity of the solid electrolyte of Comparative Example 2 was 0.012 mS/cm.

The results of Examples 1 to 7 and Comparative Examples 1 and 2 are summarized in Table 1 below. In Table 1, the first peak is a peak within a range of a diffraction angle 2θ=32.0°±0.5°, the second peak is a peak within a range of a diffraction angle 2θ=41.8°±0.5°, and the third peak is a peak within a range of a diffraction angle 2θ=50.4°±0.5°.

TABLE 1

| | | | | | Ion |
|---|---|---|---|---|---|
| | | | | | conduc- |
| | | First | Second | Third | tivity |
| | Composition | peak | peak | peak | [mS/cm] |
| Example 1 | Li_{1.8}Zr(SO₄)_{0.9}Cl₄ | Present | Present | Present | 0.34 |
| Example 2 | Li_{1.66}Zr(SO₄)_{0.83}Cl₄ | Present | Present | Present | 0.45 |
| Example 3 | Li_{1.4}Zr(SO₄)_{0.71}Cl₄ | Present | Present | Present | 0.52 |
| Example 4 | Li_{1.25}Zr(SO₄)_{0.63}Cl₄ | Present | Present | Present | 0.55 |
| Example 5 | Li_{1.1}Zr(SO₄)_{0.56}Cl₄ | Present | Present | Present | 0.49 |
| Example 6 | LiZr(SO₄)_{0.5}Cl₄ | Present | Present | Present | 0.41 |
| Example 7 | Li_{0.9}Zr(SO₄)_{0.45}Cl₄ | Present | Present | Present | 0.49 |
| Com- | Li_{1.25}Zr(SO₄)_{0.63}Cl₄ | Absent | Absent | Present | 0.015 |
| parative | | | | | |
| Example 1 | | | | | |
| Com- | Li_{1.1}Zr(SO₄)_{0.56}Cl₄ | Absent | Absent | Present | 0.012 |
| parative | | | | | |
| Example 2 | | | | | |

The solid electrolytes of Examples 1 to 7 in which the first peak, the second peak, and the third peak were confirmed had larger ion conductivity than those of the solid electrolytes of Comparative Examples 1 and 2 in which the first peak and the second peak were not confirmed.

### INDUSTRIAL APPLICABILITY

The solid electrolyte according to the present embodiment has excellent ion conductivity and thus is suitably applied to a solid electrolyte battery.

### REFERENCE SIGNS LIST

10 Solid electrolyte layer
20 Positive electrode
22 Positive electrode current collector
24 Positive electrode mixture layer
30 Negative electrode
32 Negative electrode current collector
34 Negative electrode mixture layer
40 Power generation element
50 Exterior body
52 Metal foil
54 Resin layer
60, 62 Terminal
100 Solid electrolyte battery

1. A solid electrolyte comprising, as main elements: lithium; zirconium; sulfur; oxygen; and chlorine,
wherein in an X-ray diffraction pattern using Cu-Kα as a radiation source, peaks are confirmed at a diffraction angle 2θ=32.0°±0.5°, a diffraction angle 2θ=41.8°±0.5°, and a diffraction angle 2θ=50.4°±0.5°.

2. The solid electrolyte according to claim 1, wherein the solid electrolyte is represented by LiₐZr(SOₓ)_{b}Cl₄ . . . (1), and
the formula (1) satisfies 0.9≤a≤1.8, 0.4<b<1.0, and 0<x≤4.0.

3. A solid electrolyte battery comprising:
a positive electrode;
a negative electrode; and
a solid electrolyte layer sandwiched between the positive electrode and the negative electrode,
wherein the solid electrolyte layer contains the solid electrolyte according to claim 1.
